(19) United States
(12) Patent Application Publication
(10) Pub. No.: US 2016/0359237 A1
(43) Pub. Date: Dec. 8, 2016

(54) WIDEBAND ANTENNA STAR ARRAY

(71) Applicant: SMART ANTENNA SYSTEMS, INC., Placentia, CA (US)

(72) Inventors: CLIFTON QUAN, PLACENTIA, CA (US); RICK STURDIVANT, PLACENTIA, CA (US); IRVING LANDREY, PLACENTIA, CA (US)

(21) Appl. No.: 15/117,435

(22) PCT Filed: Feb. 9, 2015
(86) PCT No.: PCT/US2015/015075

§ 371 Date: Aug. 8, 2016

Related U.S. Application Data
(60) Provisional application No. 61/937,532, filed on Feb. 8, 2014.

(51) Int. Cl. H01Q 15/18; H01Q 1/24; H01Q 1/36; H01Q 21/24

(52) U.S. Cl. CPC H01Q 15/18; H01Q 21/24; H01Q 1/243; H01Q 1/36

(57) ABSTRACT

This invention provides a wideband switchable, reconfigurable and steerable antenna star array capable of providing full 360 degree coverage and selectable narrower beam coverage with high isolation across the full cellular and bandwidth. This invention enables the small cell to have increased data throughput capacity because of the availability the wider band through a single aperture. In addition this invention increases the functionality of the small cells because it covers both the GSM cellular and Wi-Fi frequency bands with a single aperture. The directional antenna elements within the array are used to isolate and minimize interference from unwanted signals from other cell sites (macro or small) as needed. The full wideband frequency capabilities enable the operator to send data and other command to other devices in addition to smartphones with greater adaptability and inter-cell interference management/coordination by cross scheduling frequency hopping/channel control, selective blanking, multiple input multiple output (“MIMO”) and cognitive radio techniques.

### CLAIM OF PRIORITY

This application claims priority to U.S. Provisional Patent Application No.

61/937,532 filed on Feb. 8, 2014 titled “Wideband. Antenna Star Array” which is incorporated by reference in its entirety.

### BACKGROUND OF THE INVENTION

Field of the Invention

This invention provides an improved antenna for use with mobile devices. Specifically, this invention provides a wideband switchable, reconfigurable and steerable antenna star array capable of providing full 360 degree coverage and selectable narrower beam coverage with high isolation across the full cellular and Wi-Fi bandwidth.

Related Art

With the increase in sales and use of smart phones, tablets and other wireless devices, the volume of wireless data is predicted to exceed that of wired data. One way that this enormous data capacity can be realized, while meeting customer quality of service expectations and operators' requirements for cost-effective service delivery, is a significant ramping of small cell deployment.

Users typically want to use their mobile phones wherever they are—at home, at work or anywhere in-between. Users expect ubiquitous coverage on the go and innovative mobile data services with sufficient bandwidth to enjoy a complete line of mobile device functional at any time. Yet as is often the case, a significant challenge exists for mobile network operators in their quest to provide full or even adequate in-building coverage. Likewise, hilly areas in rural areas usually indicate inadequate quality of service or no service at all. Additional challenges exist for network carriers to find cost-effective solutions for providing mobile service coverage and capacity in dense urban areas. For mobile network operators, improving user experience in the home, office, or in public spaces is essential for reducing churn and gaining market share and new revenues.

Current antennas on the market for small cells consist of variations of microstrip patch, Inverted F and Inverted L antennas. They can be arrayed to form a beam for selective areal coverage and isolation. While they can be designed for multiple bands to cover either the cellular or Wi-Fi frequency spectrum, they are narrow band and not capable of operating across the full 800 MHz to 2.8 GHz band.

A custom collection of multiple antennas operating at different bands has been used, but they occupied a large volume and are susceptible to interference within the collects and between other macro cells and small cells in the area. Wideband dipoles, flared notches, flared dipoles and loaded quarter-wave cavity backed long slots may be able to operate across the full band, but they are too large in size for practical small cells in building and in home installations.

Conventional monopole antennas are smaller than dipoles and can operate across the full hand. Monopoles are typically used as omnidirectional antennas because of their associated radiation patterns. Monopole elements have been used in antenna arrays with limited beam-forming and beam-steering capability across the full band due to mutual coupling. However, monopole antennas are susceptible for interference from other macro cells and small cells in the area. Monopoles can also be susceptible to interference from other monopoles within the same unit.

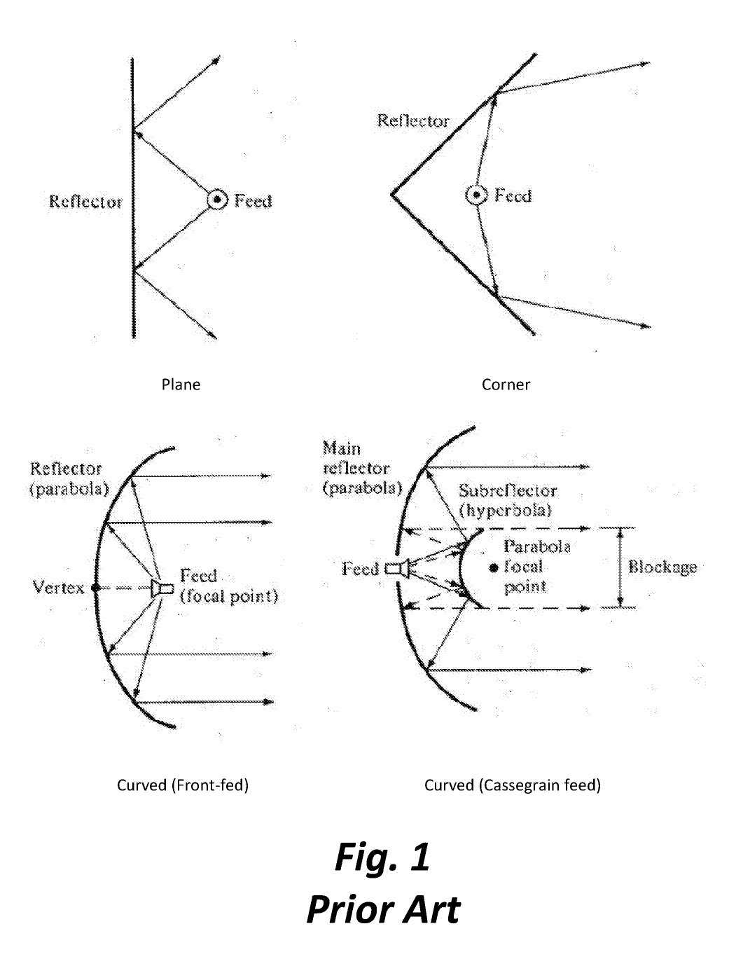

Reflectors are typically used to redirect the radiation of a dipole and waveguide horns in a desire direction. FIG. 1 shows a comparison of various reflector antenna systems in very simplified perspective. Typically, the feed used to illuminate the reflector is either a dipole or waveguide horn antenna. Reflector antenna systems tend to be large and bulky with additional mounting structures to physical support the dipole and waveguide horn. These mounting structures often block and reflect RF signals back into the feed antenna and do not contribute to the main beam. Also, corner reflectors have been used in passive targets for radar and communication applications. Corner reflector backed antennas, e.g. dipole fed, have also been used for home televisions for the receive signal only. All these application are for passive single corner reflector antennas.

FIG. 1 is a prior art block diagram illustrating a comparison of geometrical configurations for reflector system where the corner reflector is the simplest configuration to effectively collimate and direct RF energy in the forward direction as taught by Balanis, Constantine A., Antenna Theory: Analysis and Design, 3^{rd} Edition; John Wiley & Sons, Inc., 2005).

Small cells are low-powered radio access nodes that operate in licensed and unlicensed spectrum having a typical range between ten (10) meters and one (1) or two (2) kilometers. Small cells encompass femtocells, picocells and microcells. Small cells are small mobile base stations that improve in-building cellular coverage and provide a small radio footprint that can range from ten (10) meters within urban and in-building locations to two (2) km in rural locations. Currently, different sets of equipment are used for GSM and Wi-Fi coverage. For example, today's small cells only cover GSM cellular frequency bands while separate “access points” and “wireless extenders” cover the Wi-Fi bands.

While advances in silicon mix-signal technology have expanded the RF electronics within the small cell unit to cover the cellular and Wi-Fi frequency band from 800 MHz to 2.8 GHz, the problem is that the antenna currently being used does not cover the full frequency band, nor do they provide sufficient areal coverage and selectivity across the full bandwidth.

### SUMMARY

This invention provides a wideband switchable, reconfigurable and steerable antenna star array capable of providing full 360 degree coverage and selectable narrower beam coverage with high isolation across the full cellular and Wi-Fi bandwidth. This invention enables the small cell to have increased data throughput capacity because of the availability the wider band through a single aperture. In addition this invention increases the functionality of the small cells because it covers both the GSM cellular and Wi-Fi frequency bands with a single aperture. The directional antenna elements within the array are used to isolate and minimize interference from unwanted signals from other cell sites (macro or small) as needed. The full wideband frequency capabilities enable the operator to send data and other command to other devices in addition to smartphones with greater adaptability and inter-cell interference management/coordination by cross scheduling frequency hopping/channel control, selective blanking, multiple input—multiple output (“MIMO”) and cognitive radio techniques.

The invention is a switchable and reconfigurable polygonal antenna star array having corner reflector backed wideband monopole radiating elements. The corner reflector backed wideband monopole radiating elements are smaller than conventional wideband elements with comparable wide bandwidth capability with better isolation between elements and front to back ratio in its radiation pattern.

Being a switchable and reconfigurable polygonal antenna array, 360 degree coverage with beamforming and beam steering is achieved by turning on and off elements. Also, the RF signal from each element can be time or phased steered depending of the available electronics and then combined to form the beam. Again depending with the available electronics and software algorithms, adaptive array signal processing, fractional frequency reuse, and MIMO can be used to further shape and steering the beam(s) for greater flexibility in coverage and inter-cell interference management/coordination

Other systems, methods, features, and advantages of the invention will be or will become apparent to one with skill in the art upon examination of the following figures and detailed description. It is intended that all such additional systems, methods, features and advantages be included within this description, he within the scope of the invention, and be protected by the accompanying claims.

### DETAILED DESCRIPTION OF THE DRAWINGS

The components in the figures are not necessarily to scale, emphasis being placed instead upon illustrating the principles of the invention. In the figures, like reference numerals designate corresponding parts throughout the different views.

FIG. 1 is a prior art illustration comparing geometrical configurations for some reflector system shows that the corner reflector is the simplest configuration to effectively collimate and direct RF energy in the forward direction.

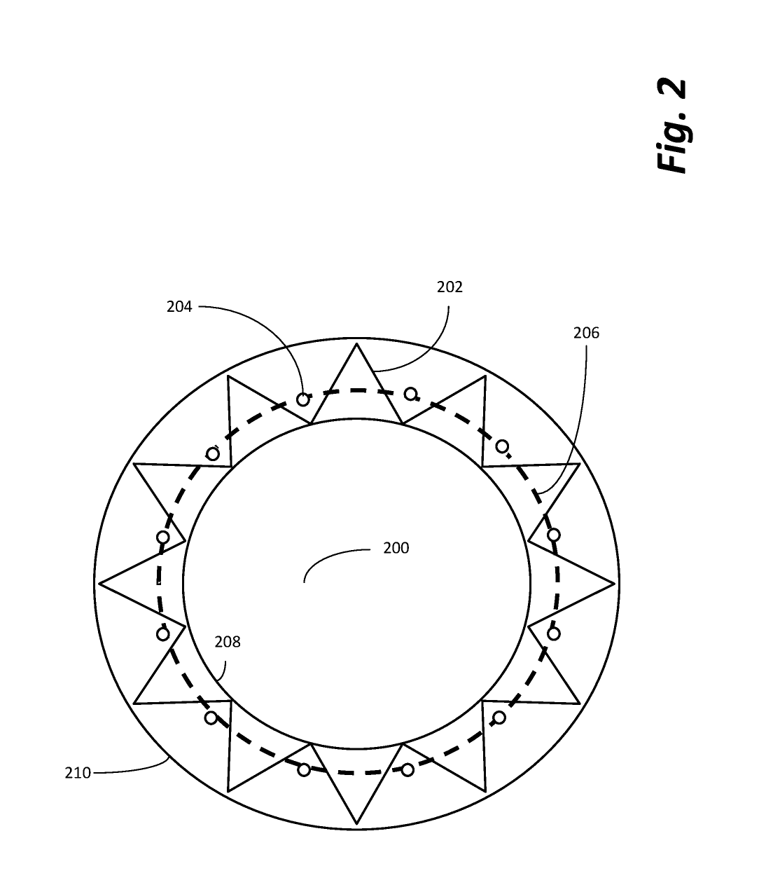

FIG. 2 is a top view of the wideband switchable polygonal/circular antenna star array.

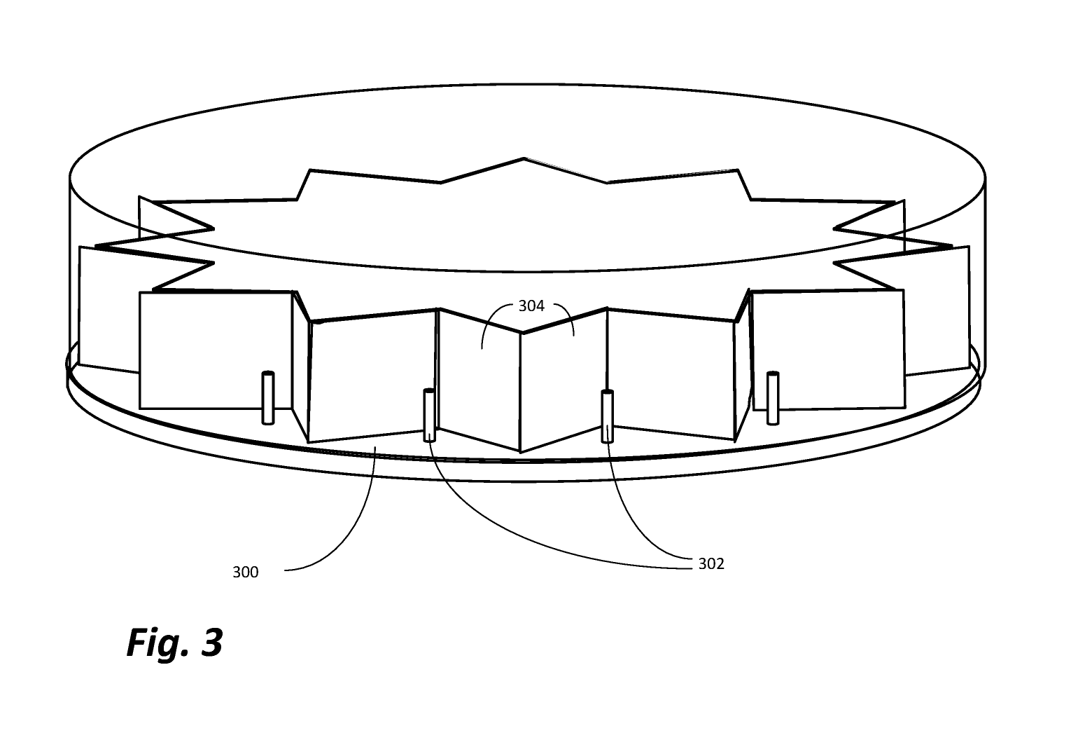

FIG. 3 is perspective view of wideband steerable polygonal/circular antenna array.

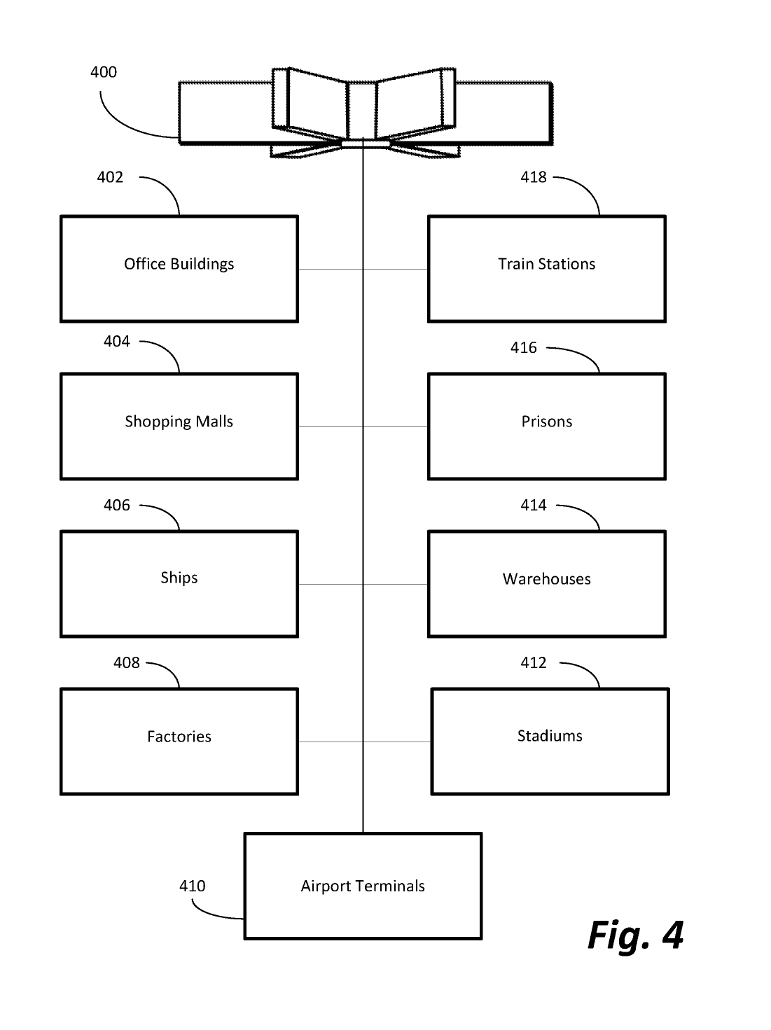

FIG. 4 is a block diagram of a wideband antenna star array that can be used to link and route data to various fixed and mobile devices within a building.

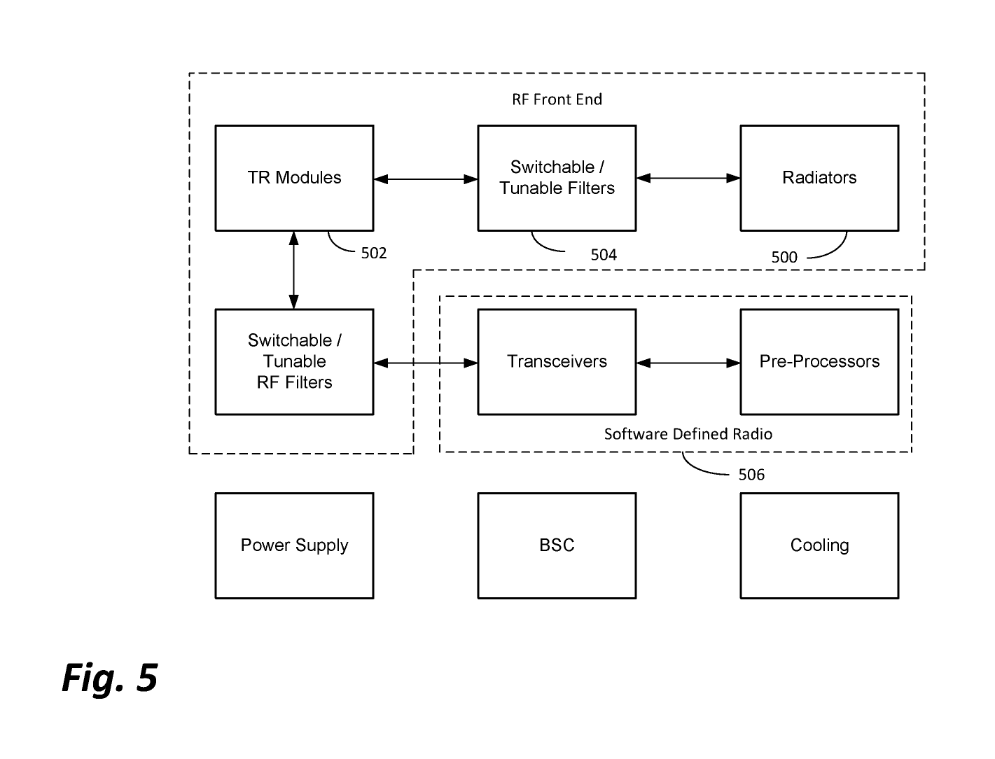

FIG. 5 is a block diagram of a first embodiment of a notional small cell RF structure illustrating a wideband antenna star array that can be used to link and route data/commands to various devices.

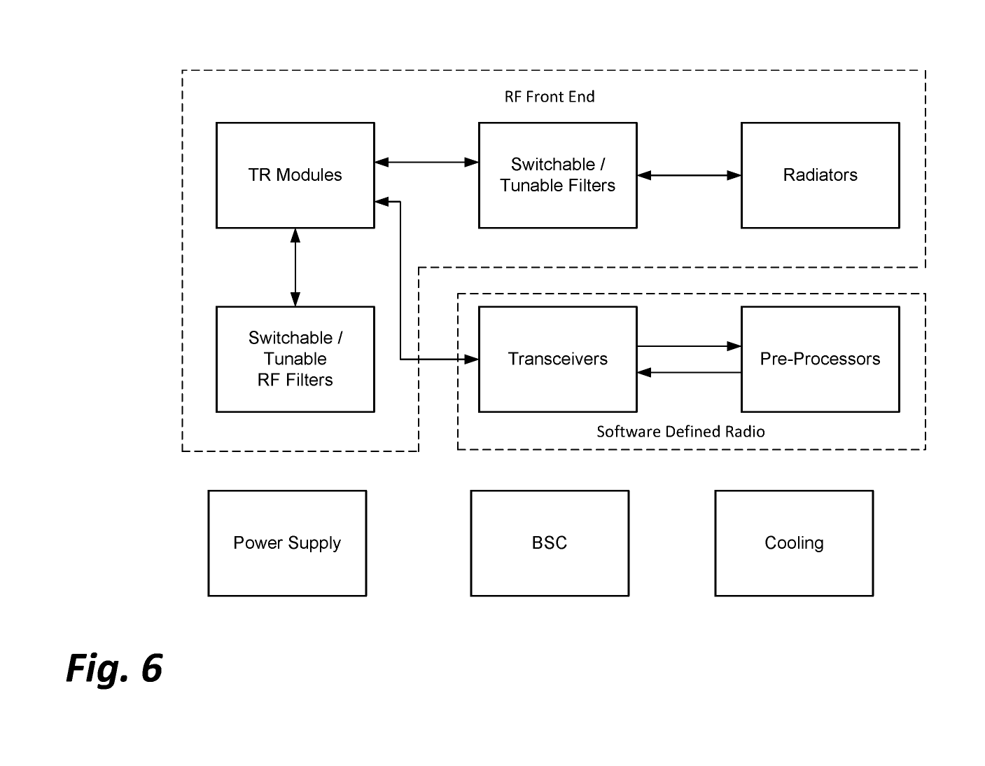

FIG. 6 is a block diagram of a second embodiment of a notional small cell RF structure illustrating a wideband antenna star array that can be used to link and route data/commands to various devices.

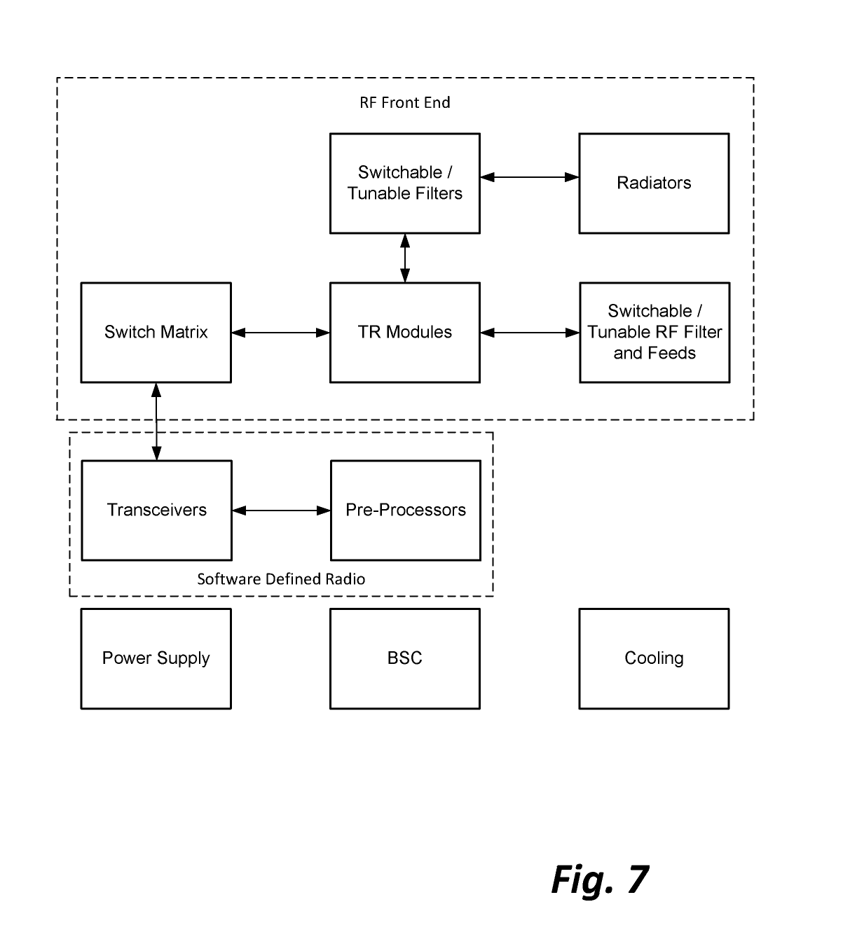

FIG. 7 is a block diagram of a third embodiment of a notional small cell RF structure illustrating a wideband antenna star array that can be used to link and route data/commands to various devices.

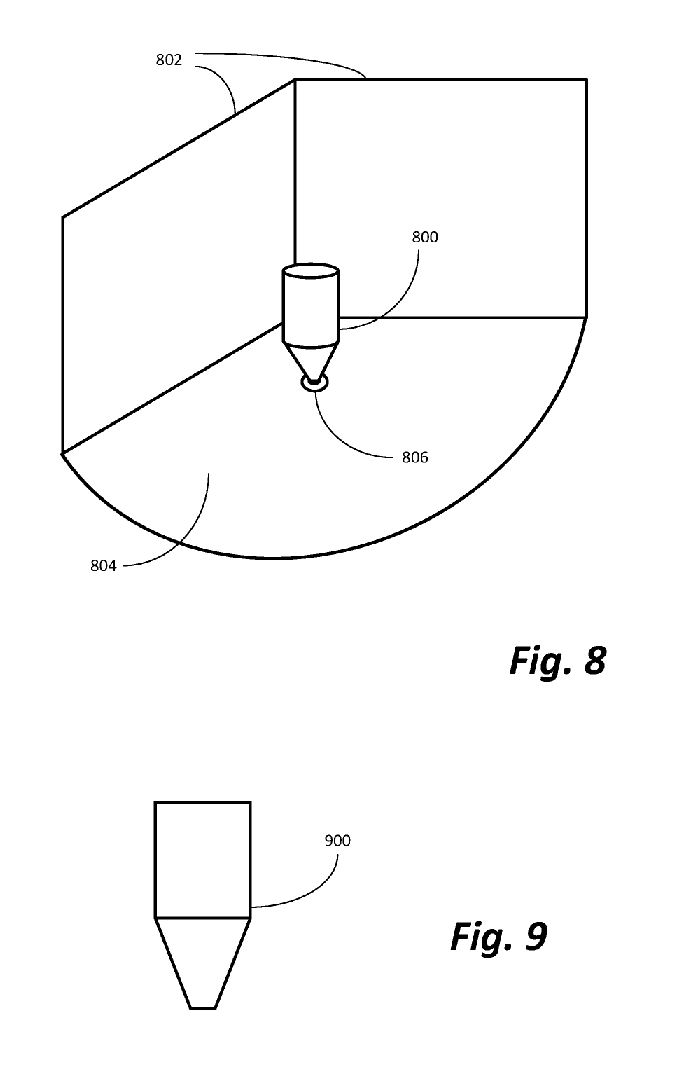

FIG. 8 is a perspective view of a corner reflector backed monopole antenna using a cylindrical probe and construction and a side view of a cylindrical probe.

FIG. 9 is a side view of a cylindrical probe.

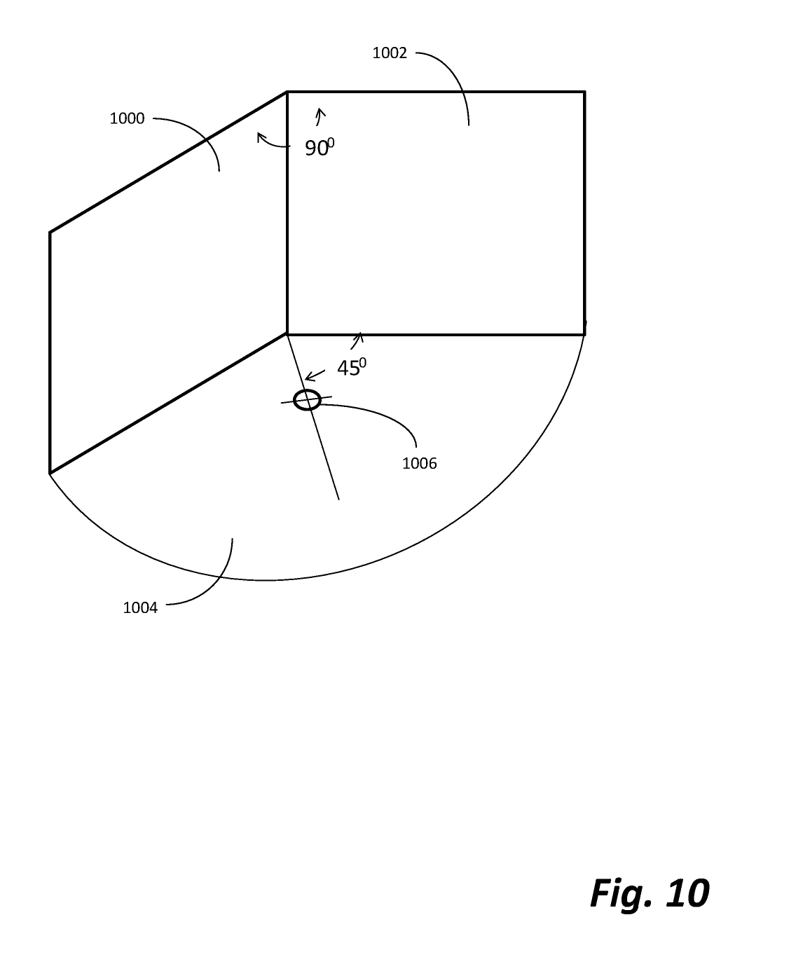

FIG. 10 is a perspective view of the distances between the monopole feed point and corner reflects are small compared to a wavelength.

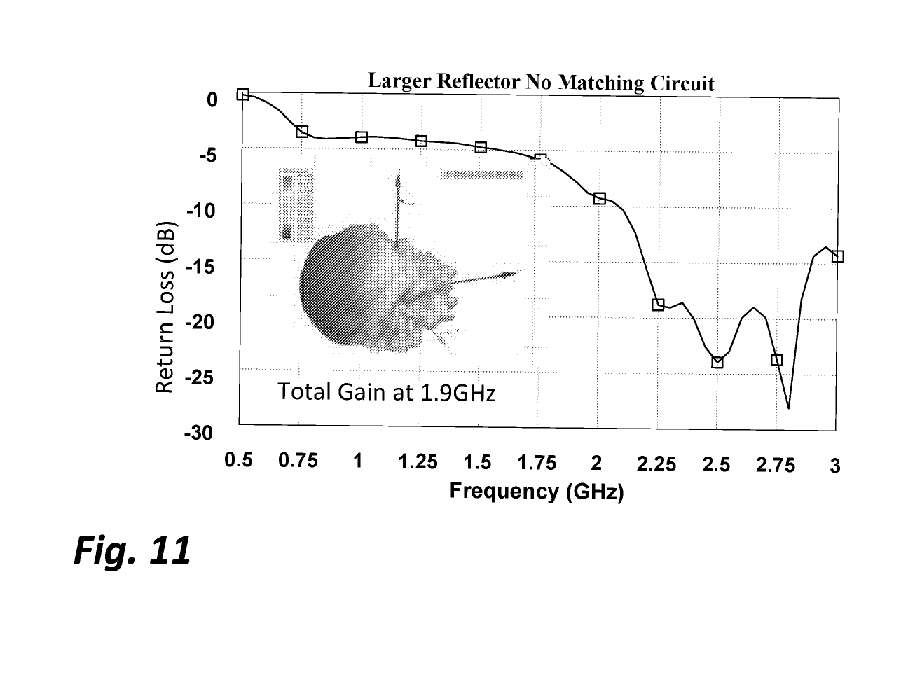

FIG. 11 is a graph illustrating corner reflector backed monopole antenna concept using a cylindrical probe has been modeled and analyzed using HESS 3D EM modeling tool.

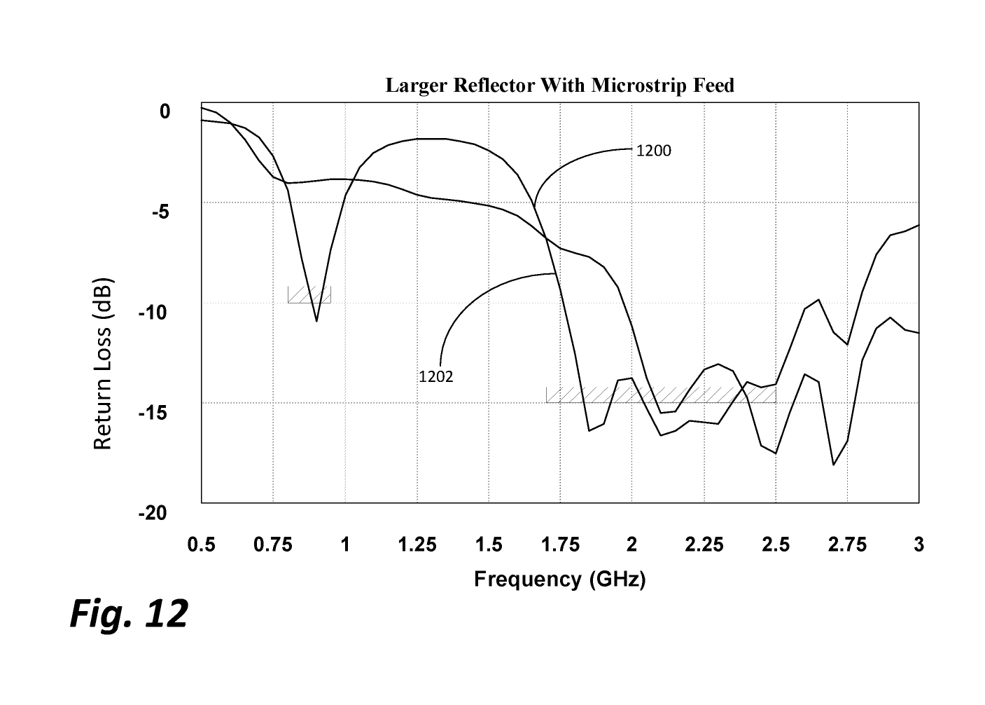

FIG. 12 is a graph illustrating a microstrip matching circuit has been designed to improve the match across the 800 MHz to 2.8 GHz frequency band.

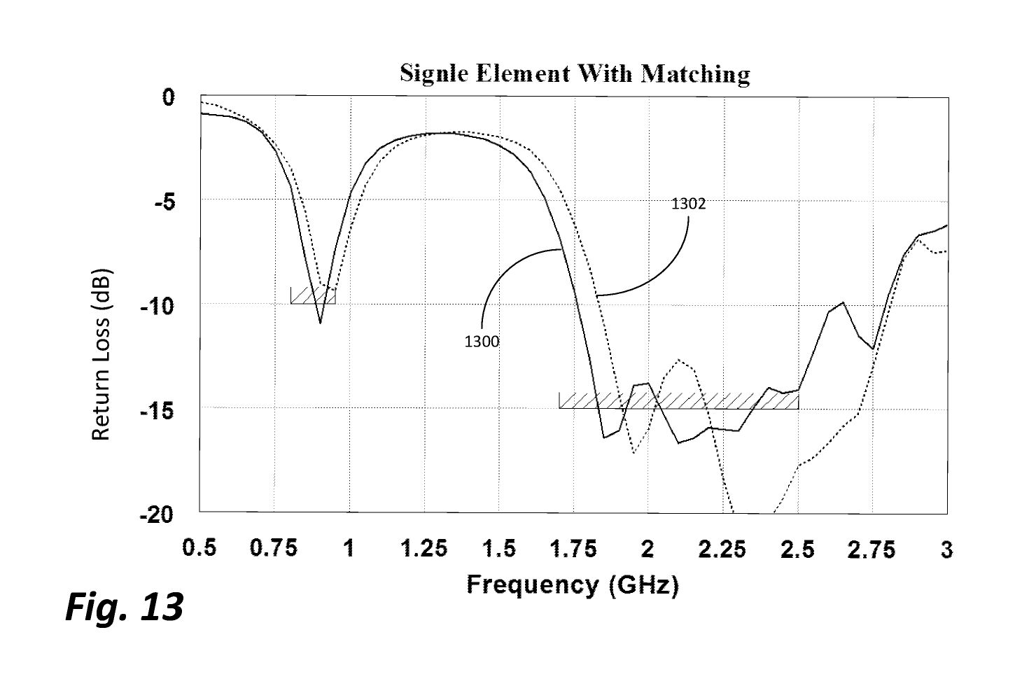

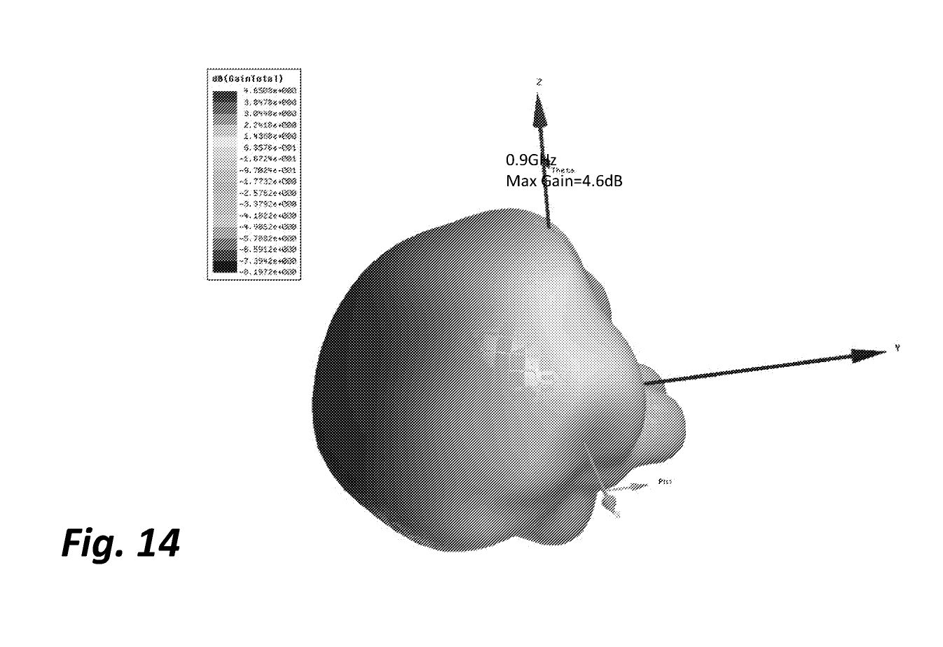

FIG. 13 is a graph illustrating a comparison of predicted performances shows the correlation between ANSOFT HFSS 3D EM modeling tool and Agilent Advanced Design System (ADS) Circuit Simulator Tool.

FIG. 14 is a graph illustrating 3D plots of the antenna radiation pattern predicted for the corner reflector backed monopole showing the wide band performance at three different frequencies.

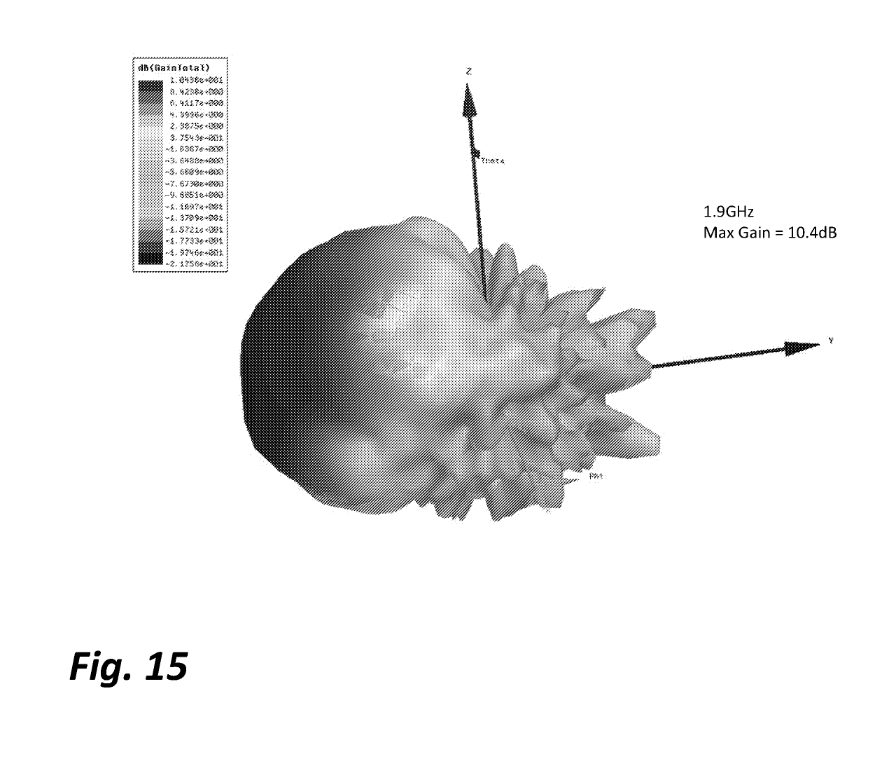

FIG. 15 is a graph illustrating 3D plots of the antenna radiation pattern predicted for the corner reflector backed monopole showing the wide band performance at three different frequencies.

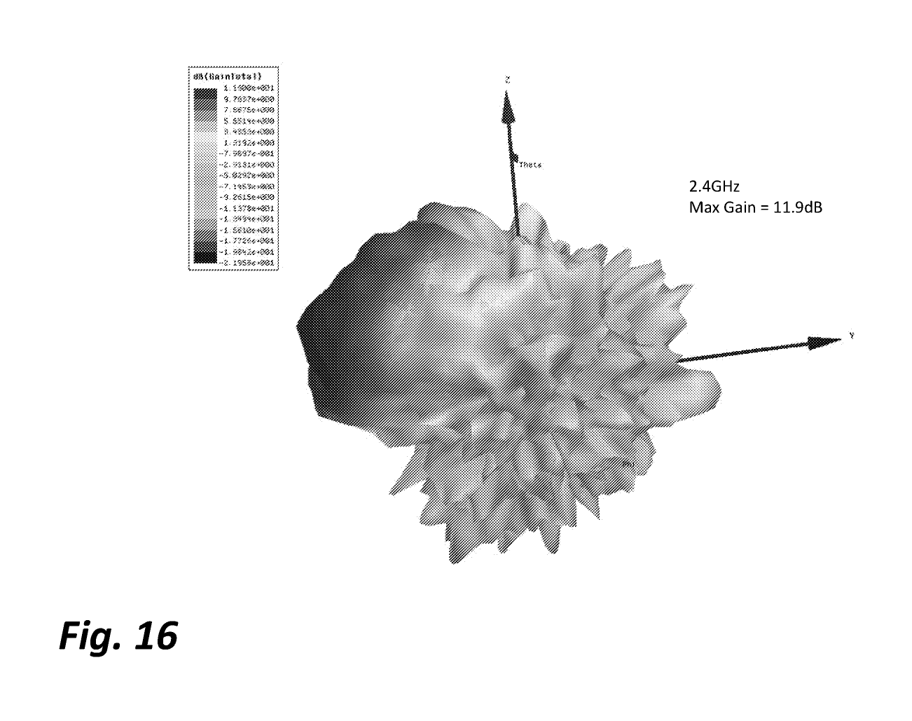

FIG. 16 is a graph illustrating 3D plots of the antenna radiation pattern predicted for the corner reflector backed monopole showing the wide band performance at three different frequencies.

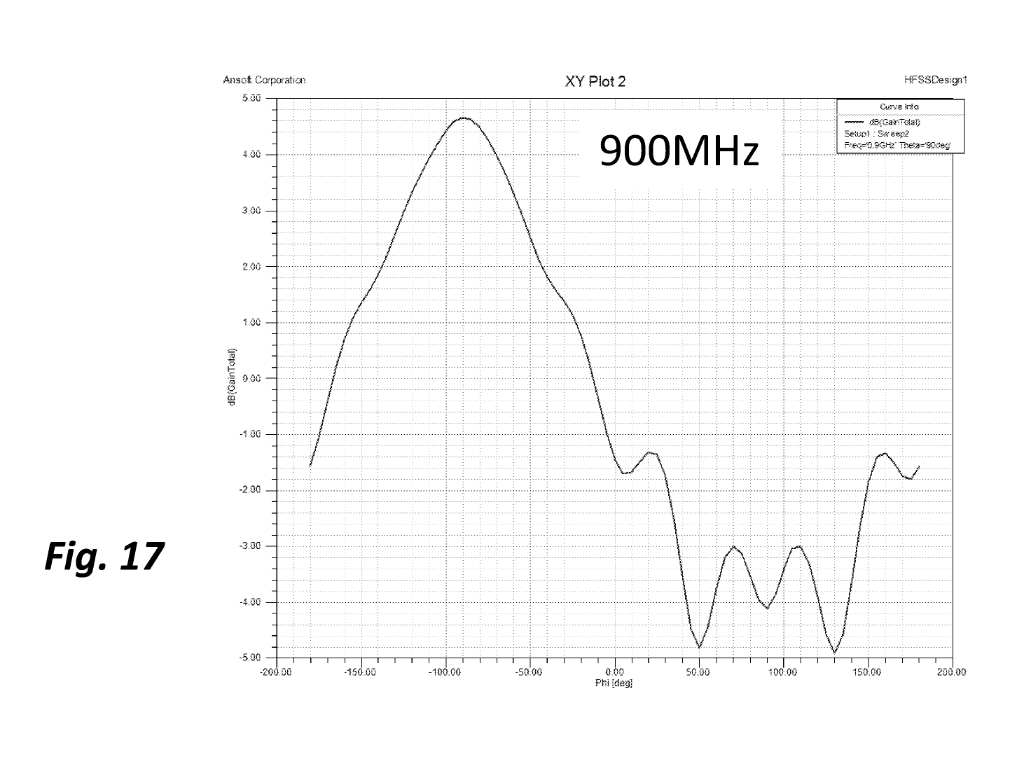

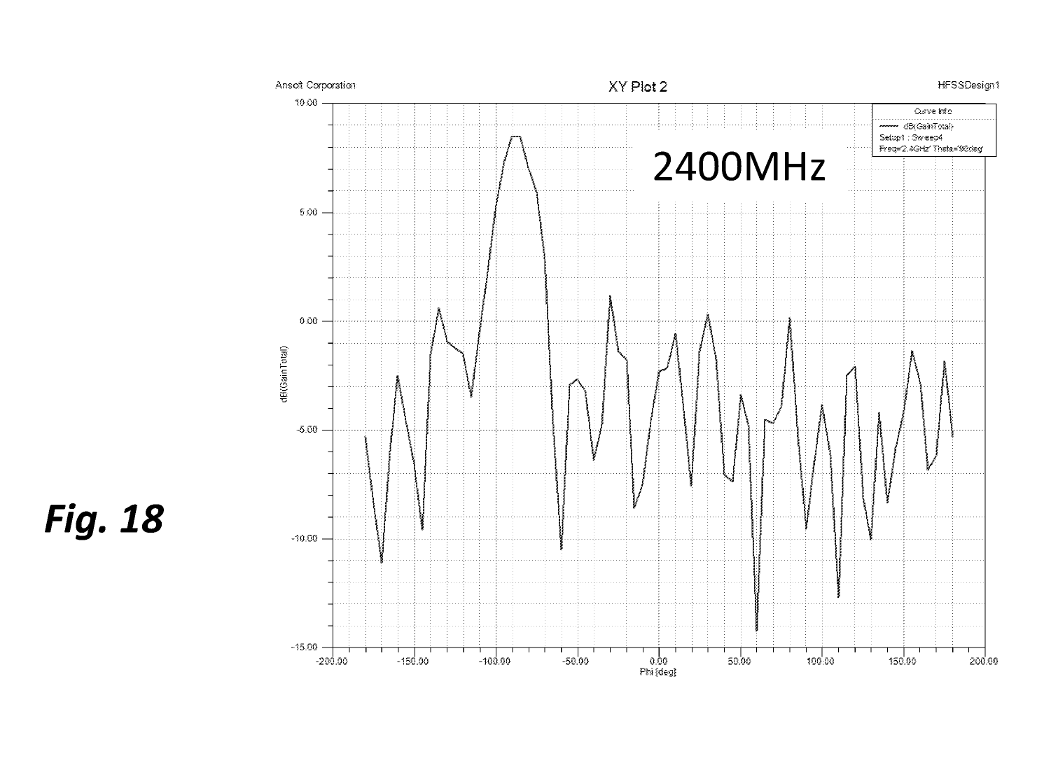

FIG. 17 is an illustration of the model generated using the HFSS 3D EM modeling tool for analysis.

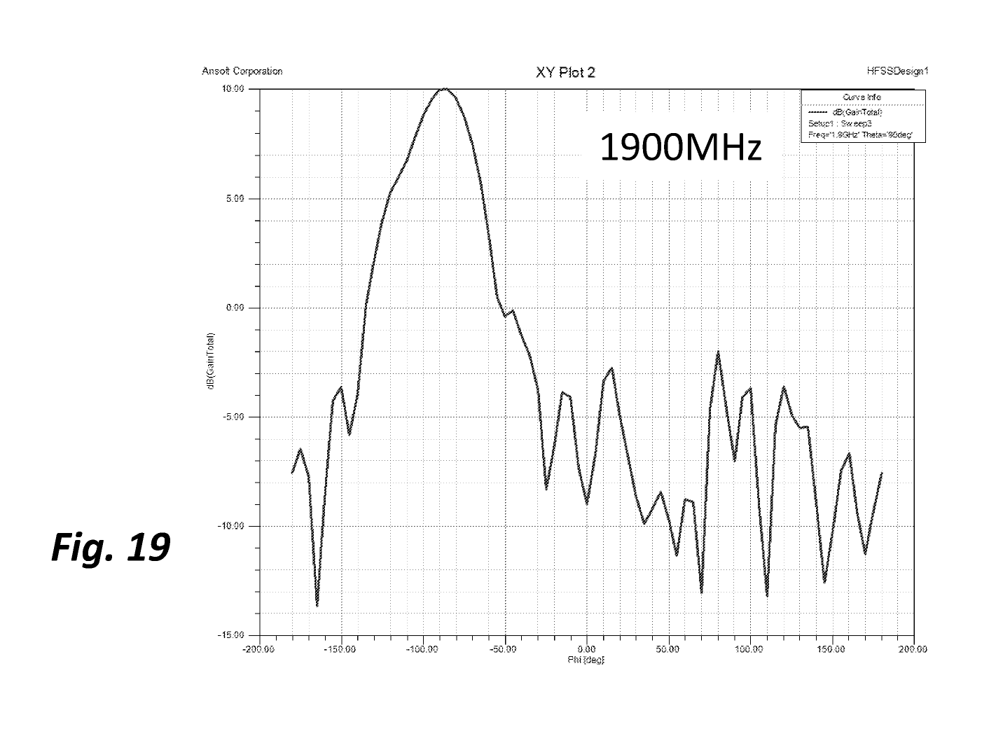

FIG. 18 is a graph illustrating 2D cuts of the antenna radiation pattern predicted for the corner reflector backed monopole show the wide band performance.

FIG. 19 is a graph illustrating 2D cuts of the antenna radiation pattern predicted for the corner reflector backed monopole show the wide band performance.

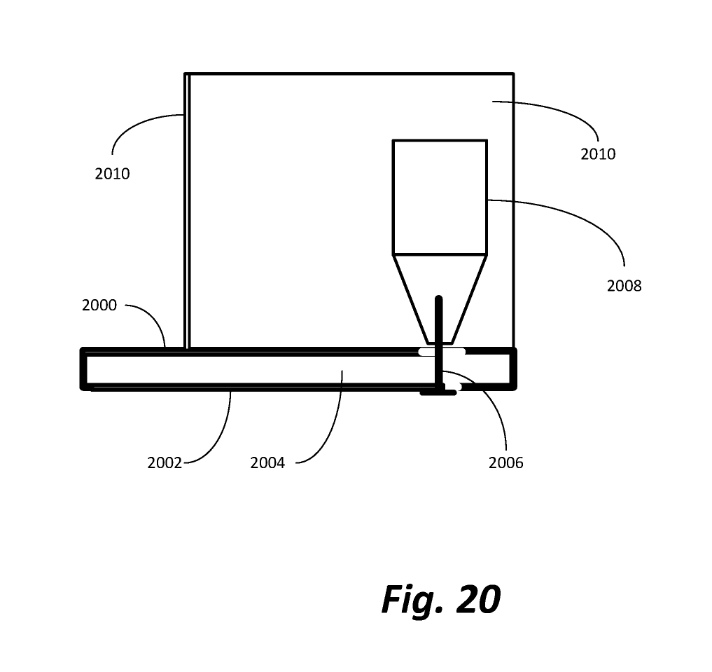

FIG. 20 is a side cutaway view of an excitation of the monopole probe used to send the RF signal from a channelized microstrip line to a coaxial pin running through the circuit hoard to the probe.

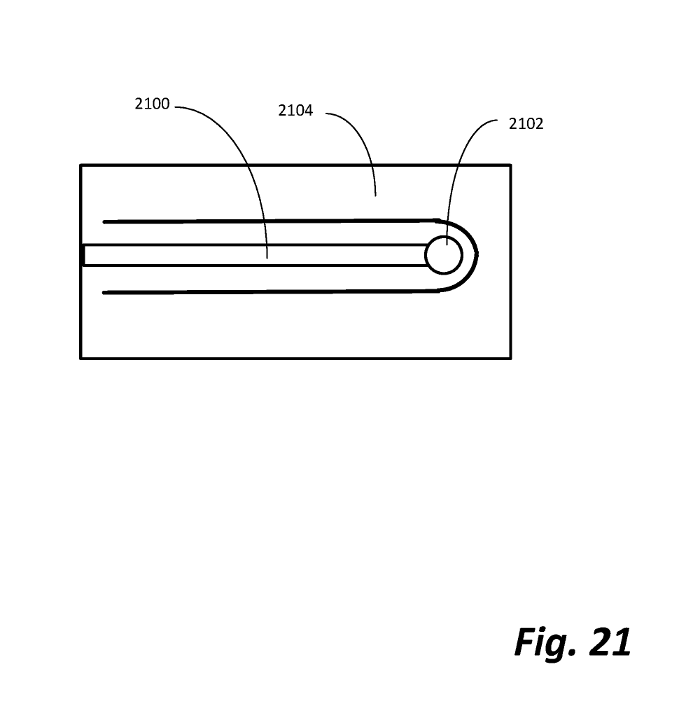

FIG. 21 is a bottom view of the microstrip line.

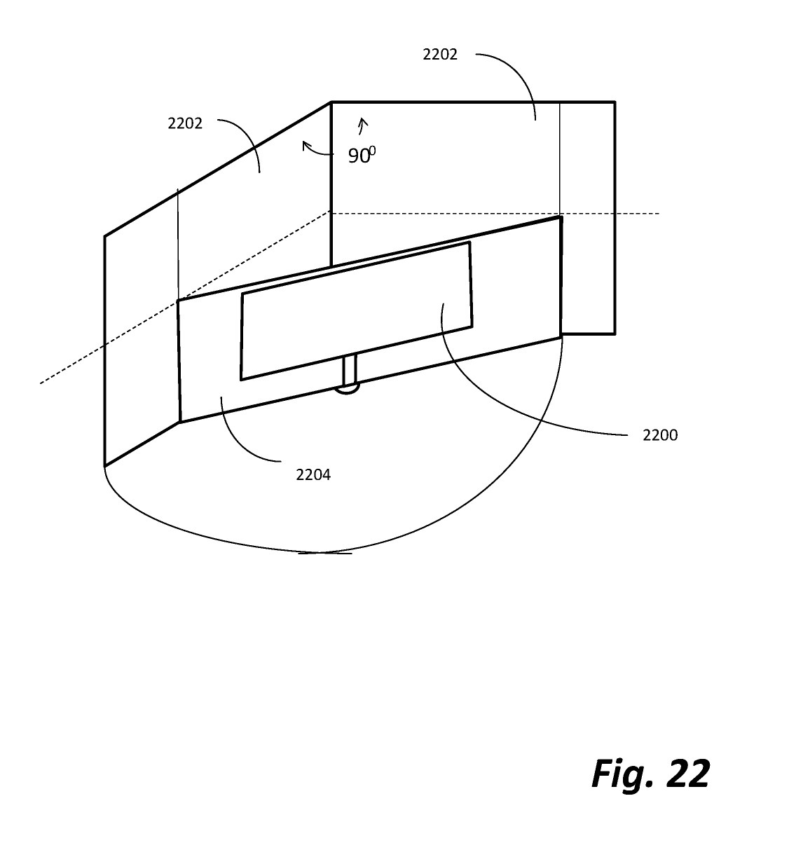

FIG. 22 is a side and top view of a corner reflector backed monopole antenna concept using a printed patch probe.

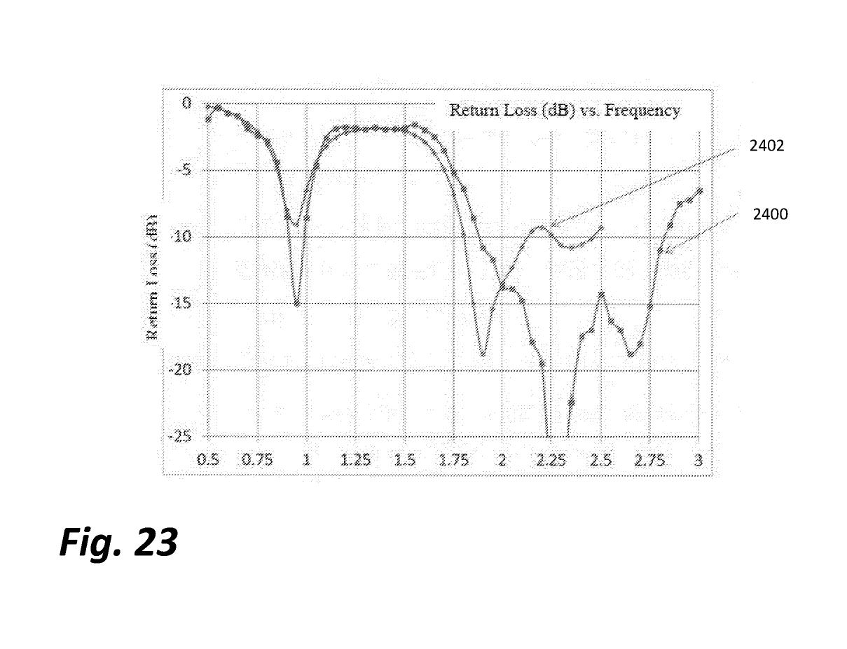

FIG. 23 is a graph comparison of predicted and measured performances that show the correlation between the HESS Model and the prototype corner reflector backed monopole antenna element.

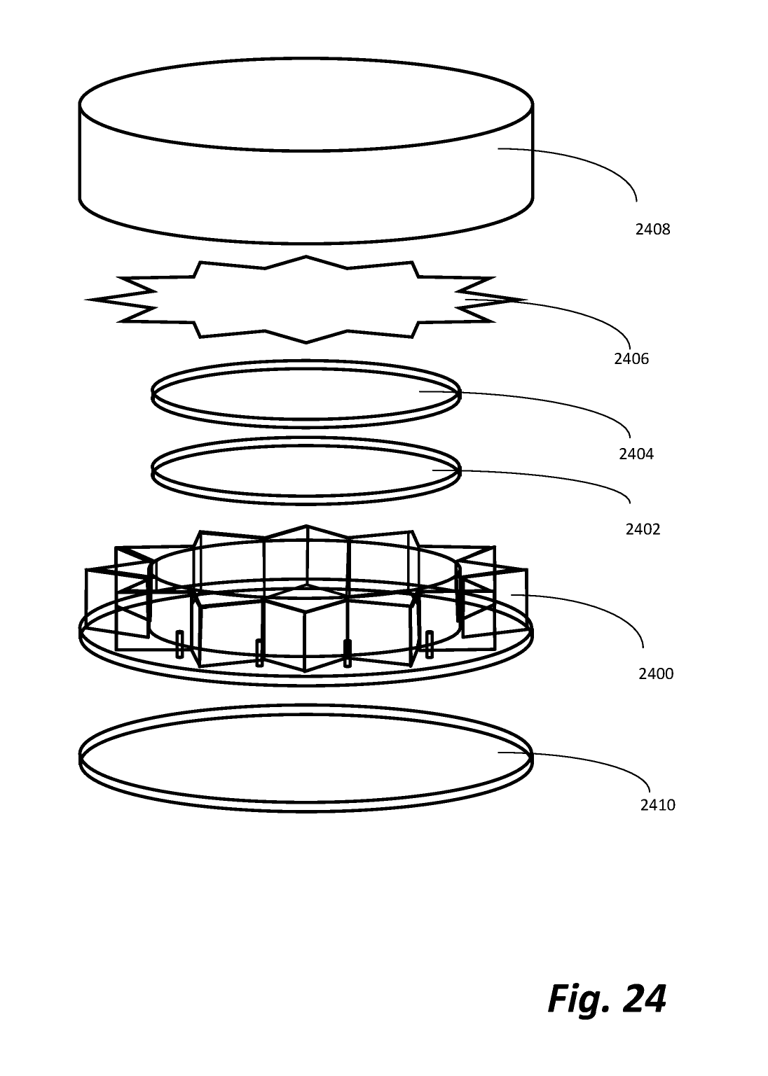

FIG. 24 is an exploded view of the star array small electronic assembly structure.

FIG. 25 is a perspective view of a star array antenna mother board sub-assembly structure.

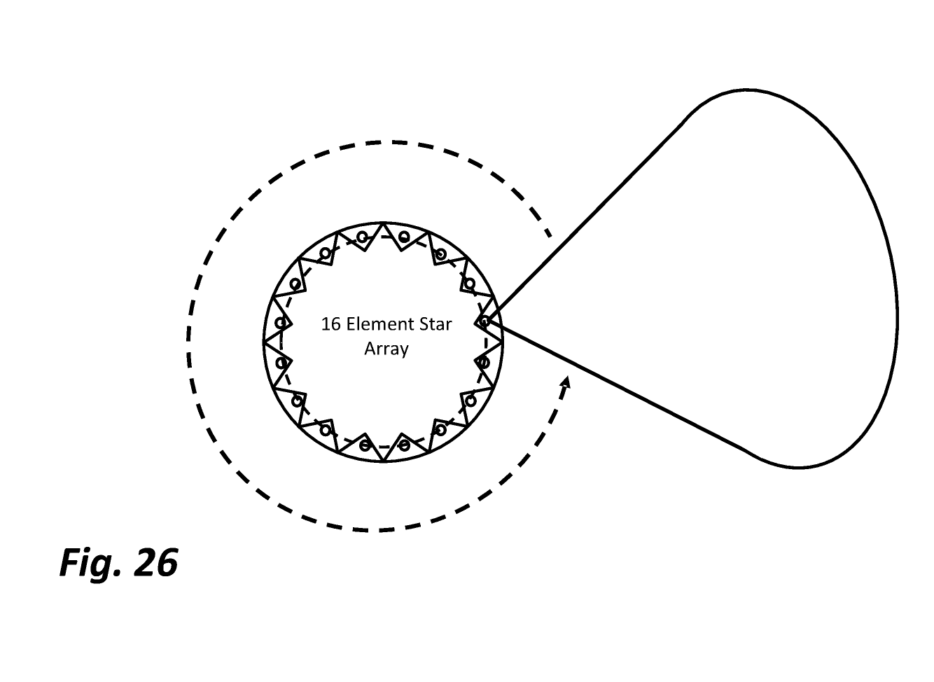

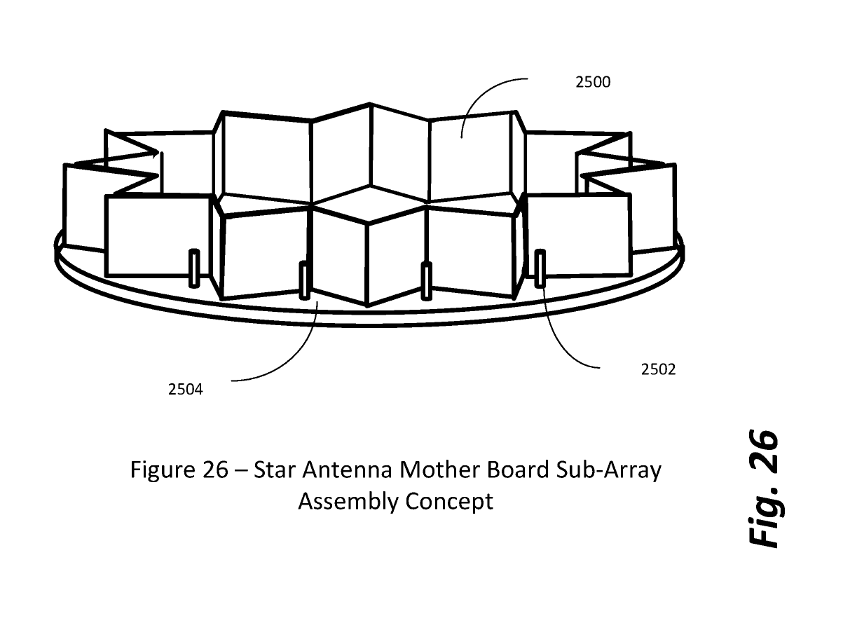

FIG. 26 is a top view of a system capable of switching on and off single beams enables the Star Array Antenna to cover 360°.

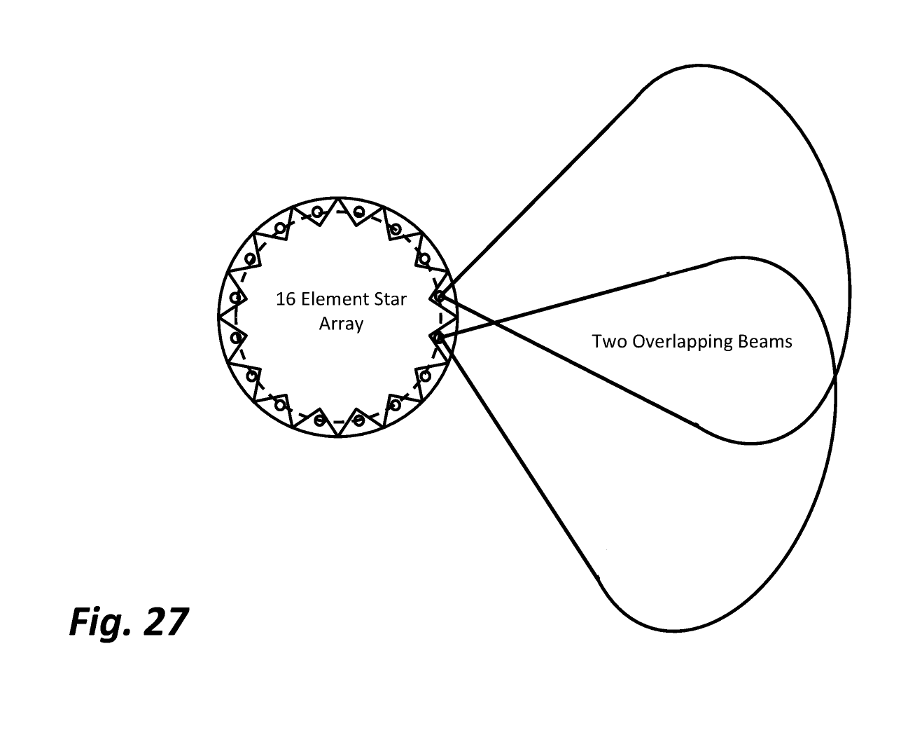

FIG. 27 is a top view of a system with two (2) adjacent element turned enable the star array antenna to perform discriminative coverage and evaluation.

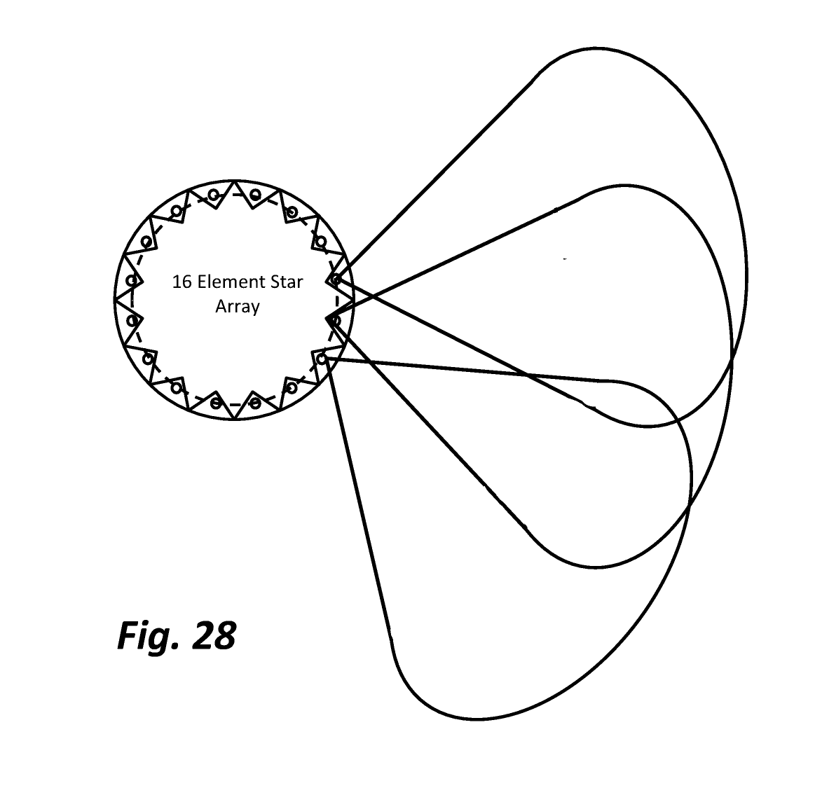

FIG. 28 is a top view of a system with three (3) adjacent element turned enable the star array antenna to perform discriminative coverage and evaluation.

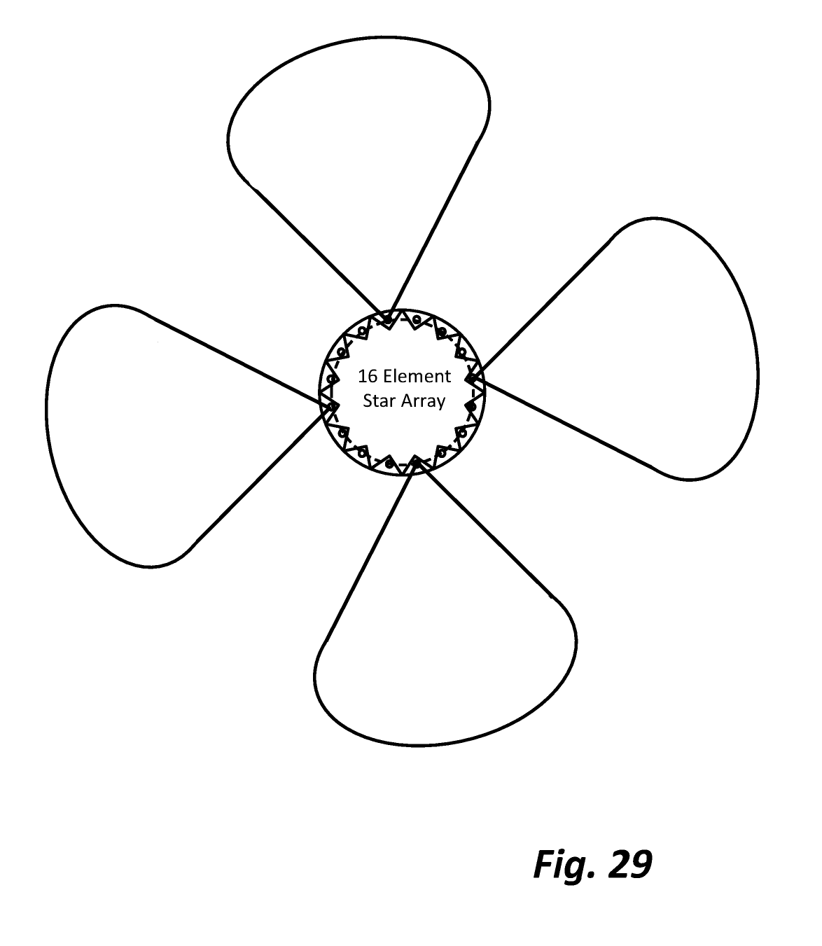

FIG. 29 is a top view of a system with four (4) independent elements turned on allowing simultaneous 360° coverage of multiple user/devices.

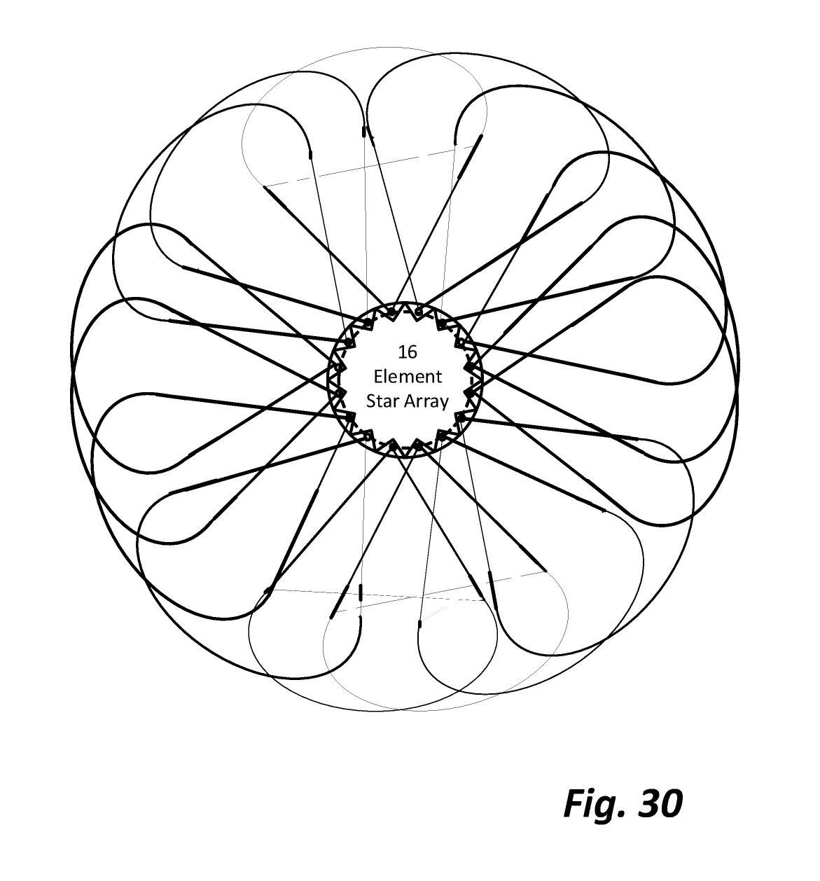

FIG. 30 is a top view of a system with sixteen (16) independent elements turned on allowing simultaneous 360° coverage of multiple user/devices.

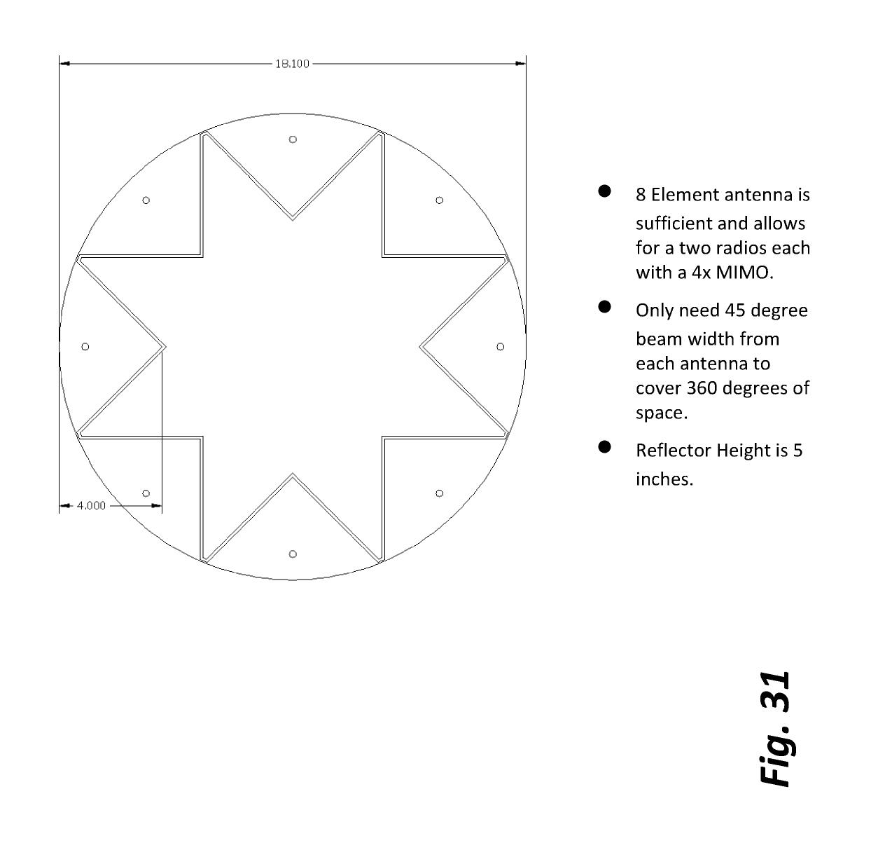

FIG. 31 is a top view of a system CAD model of an eight (8) element star array.

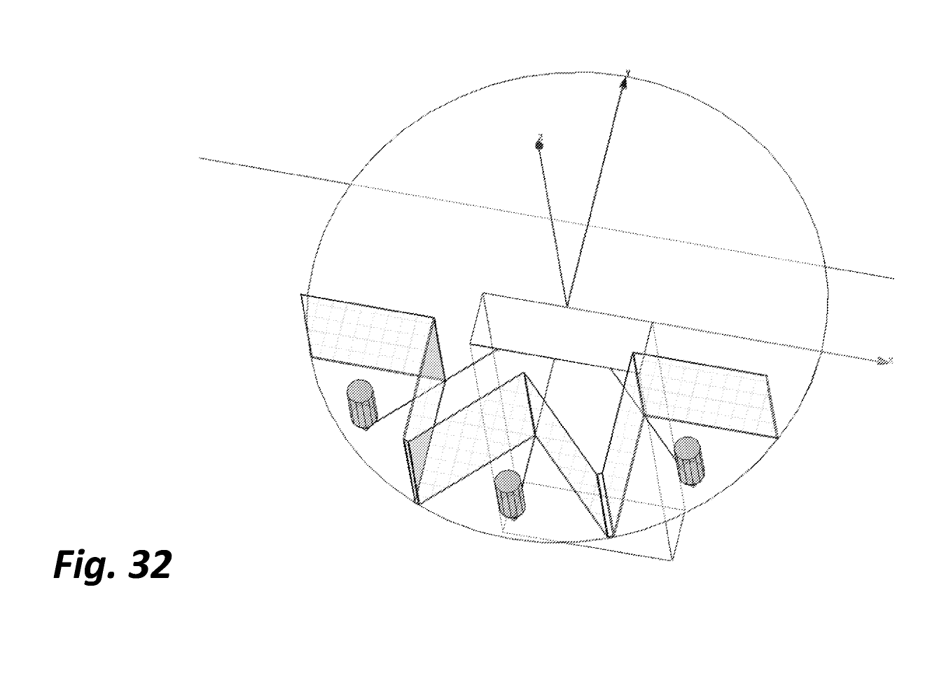

FIG. 32 is a top view of a system with adjacent elements with the eight (8) element the Star Array Antenna have better than 20 dB isolation across the full frequency band.

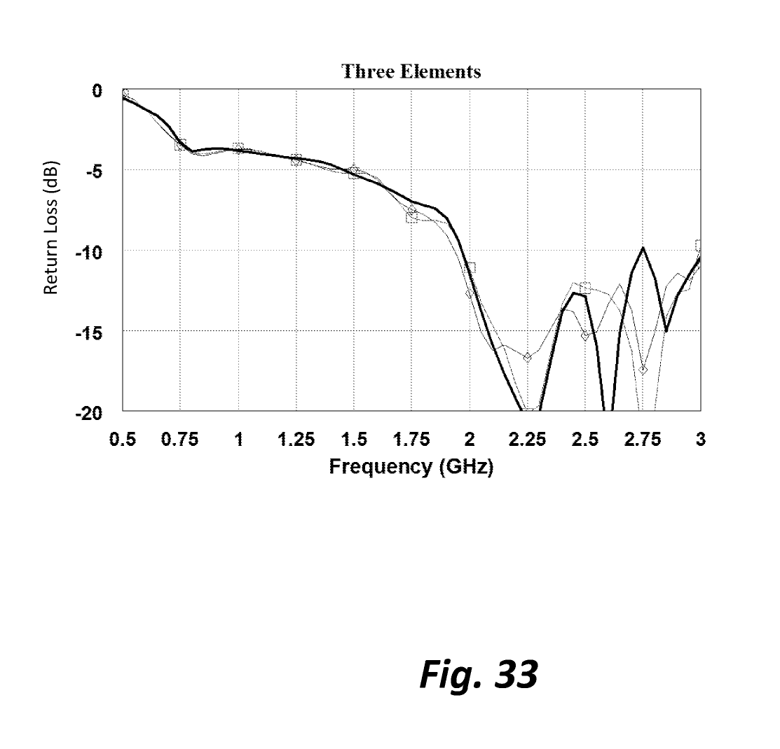

FIG. 33 is a chart of the input return loss into each element showing that it is about the same for the three adjacent elements within the eight (8) element star array antenna. across the full frequency band.

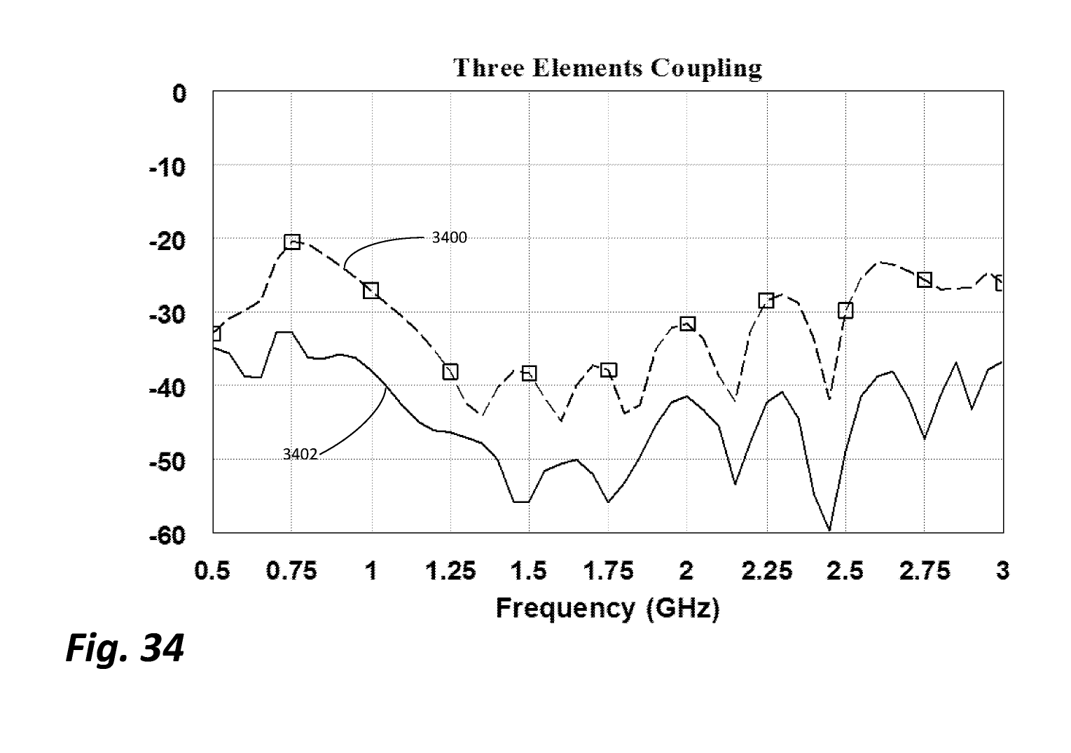

FIG. 34 is a graph of adjacent elements with the eight (8) element star array antenna having better than twenty (20) dB isolation across the full frequency band.

### DETAILED DESCRIPTION

Small cells are low-powered radio access nodes that operate in licensed and unlicensed spectrum that have a range of ten (10) meters to one (1) or two (2) kilometers (“km”). Small cells encompass femtocells, picocells and microcells. Small cells are small mobile base stations that improve in-building cellular coverage and provide a small radio footprint, which can range from ten (10) meters within urban and in-building locations to two (2) km for a rural location. While advances in silicon mix-signal technology has expanded the RF electronics within the small cell unit to cover the cellular and Wi-Fi frequency band from 800 MHz to 2.8 GHz, the problem is that the antenna currently being used do not cover the full frequency band nor do they provide sufficient areal coverage and selectivity across the full bandwidth.

To address increasing the capacity and capabilities of small cells, a wideband switchable, reconfigurable and steerable polygonal/circular antenna “star” array as shown in FIG. 2 is capable of providing full 360 degree coverage and selectable narrower beam coverage with high isolation across the full cellular and Wi-Fi bandwidth. The GSM coverage by the small cells and Wi-Fi. coverage by access points/extenders can be combined with a single antenna aperture instead of a multitude of different antenna. This invention will enlarge the data and RF signal capacity being routed through the RF electronics within the small cell allowing communicating and controlling more devices and appliances within various structures while increasing the adaptability to manage inter-cell interferences from other cells nearby. It is conceivable in the future that using this new invention along with the appropriate software applications, one will can not only use their smart phones to communicate, transmit/receive data from the internet but also control alerts, security camera, printers, home lighting and entertainment centers, etc.

FIGS. 2 and 3 illustrate a wideband switchable and steerable polygonal/circular antenna star array. FIG. 2 is a top view of the wideband switchable polygonal/circular antenna star array. A ground plane 200 supports a plurality of angled reflectors 202 that are arranged in a circular pattern on the ground plane 200. Antenna elements 204 are positioned along the reference line 206 within the angled reflectors 202 such that RF energy transmitted by the antenna elements 204 is radiated outward and away from the center of the circular ground plane 200. The angled reflectors 202 assist in reflecting the radiated RF energy away from the center of the circular ground plane 200. Inner 208 and outer 210 housings may be used to protect the array from environmental elements.

FIG. 3 is perspective view of wideband steerable polygonal/circular antenna. array. The ground plane 300 is orthogonal to the angled reflectors 302 and a plurality of antenna. elements 304 are positioned within the angled reflectors 302 such that the plurality of antenna elements forms an array. FIG. 3 is a perspective view of an antenna circular array using reflector backed wide band monopole elements where the wide band monopole elements in this embodiment may comprising a teardrop shape with a 4:1 bandwidth. The radiating signals are launched from RF printed wiring board underneath the ground plane. The RF energy that is transmitted creates a pattern that is shaped and directed by the reflector, e.g. the corner reflector in FIG. 3.

FIG. 4 is a block diagram illustrating a wideband antenna star array that can be used to link and route data to various fixed and mobile devices within various structures. This invention will enlarge the data and RF signal capacity being routed through the RF electronics within the small cell allowing communicating and controlling more devices and appliances within an office building and large indoor and outdoor facilities while increasing the adaptability to manage inter-cell interferences from other cells nearby. It is conceivable that in the future using this new invention along with the appropriate software applications, one will can not only use their smart phones to communicate, transmit/receive data from the internet but also control alerts, security camera, printers, home lighting and entertainment centers, etc.

The wideband antenna star array 400 shown in FIG. 4 may be utilized in areas where there is an above average concentration of users such as in office buildings 402, shopping malls 404, ships 406, factories 408, aircraft terminals 410, stadiums 412, warehouses 414, prisons 416, train stations 418 and other venues where a large concentration of users can overwhelm the carrying capacity of existing network infrastructures. Finally while initially intended to be installed within indoor facilities, this invention can be applied to outdoor venues as well in order to maintain continuous access to signals that carry voice, data and video content.

FIG. 5 is a block diagram of a first embodiment of a notional small cell RF structure illustrating a wideband antenna star array that can be used to link and route data/commands to various devices. The RF front electronics used within the small cell architecture may be depicted in in FIG. 5. In this architecture, the phase and amplitude of each radiator 500 would be controlled by a wideband transmit/receive (“T/R”) module 502 for time delay beam forming and beam switching. There can be up to two stages of switchable and tunable filters 504 that can be configured to enable the new antenna system to perform full duplex at selective frequency bands. Transceivers in combination with the Field Programmable

Gate Array (“FPGA”) can create a software defined radio (“SDR”) 506 that can be controlled by a computer connected by a wired or wireless link. The SDR is a radio communication system where components that have been typically implemented in hardware (e.g. mixers, filters, amplifiers, modulators/demodulators, detectors, etc.) are instead implemented by means of software on a personal computer or embedded system. Various configurations of SDR's 506 are available commercially and the SDR 506 technology brings the flexibility, cost efficiency and power to drive communication signals. Please note, other electronics configurations may be used depending on component cost and availability.

FIG. 6 is a block diagram of a second embodiment of a notional small cell RF structure illustrating a wideband antenna star array that can be used to link and route data/commands to various devices. The RF front electronics used within the small cell architecture may be depicted in in FIG. 6.

FIG. 7 is a block diagram of a third embodiment of a notional small cell RF structure illustrating a wideband antenna star array that can be used to link and route data/commands to various devices. The RF front electronics used within the small cell architecture may be depicted in in FIG. 7.

FIG. 8 is a perspective view of a corner reflector backed monopole antenna using a cylindrical probe 800. The radiators 802 used in the switchable and reconfigurable polygonal/circular antenna array are corner reflector 802 backed wideband monopole radiating elements. The corner reflector 802 backed wideband monopole radiating elements are smaller than conventional wideband elements with comparable wide bandwidth capability with better isolation between elements and front to back ratio in its radiation pattern. The combination of the groundplane 804 and the coax 806 feed physically support the monopole element 800 so that no additional mounting structures or brackets are needed.

FIG. 9 is a side view of a cylindrical probe designed as a cylindrical probe 900 or a printed patch to operate across a wide frequency band of several octaves. The monopole antenna may be constructed as a cylinder 800 positioned on top of a narrowly tapering cone 802. The cone 802 may have angled walls or may be constructed so that there is no sharp break between the angled cone and the cylindrical walls. Because of its associated radiation patterns, conventional monopoles may be used as omnidirectional antennas making them susceptible to RF signal coming in from any direction. Making the radiation pattern more directional by placing the monopole element in a various forms of open ended waveguide cavities is shown in FIG. 8. Examples of cavities include enclosed rectangular waveguides, enclosed circular waveguides, parallel plate waveguides and enclosed wired cages. The cavity could be closed/terminated with a flat metal ground plane in the location opposite to the direction of the propagating RF signal. The result of using the open ended waveguide cavity with a termination ground plane may achieve a significant reduction in the operating frequency bandwidth down to an octave (2:1) or less. Ideally the distance between the monopole and the termination ground plane is one quarter wavelength at the center frequency of the operating band. Reducing or increasing the quarter wavelength distance between the monopole and the termination ground plane reduces the operating band,

The monopole in the waveguide cavity may be used to control the radiation pattern of the radiating element, but in and open metallized structure consist of a finite circular ground plane and two finite size metallized sheets forming the corner reflector as shown in FIG. 10. Since of boundary conditions of the open metal structure imposed on the monopole element is far different from the open ended but enclose waveguide cavity, the restriction of the quarter wavelength distance at the center frequency between the monopole and the termination ground plane (corner reflector metal sides in this invention) do not necessarily apply. The distance between the monopole and the corner reflector metal sides in this invention is a little over one quarter at the highest frequency of the band and less than one tenth wavelength at the lowest frequency which is a significant size reduction for directional antenna operating a comparable bandwidth.

FIG. 10 is a perspective view of a corner reflector backed monopole antenna using a cylindrical probe construction. The corner reflectors 1000 and 1002 may be positioned orthogonal to the ground plane 1004. A cylindrical monopole feed point coax 1006 may be positioned so that the RF energy can radiate outward in a direction parallel to the ground plane 704. The corner reflectors 1000 and 1002 reflect the RF energy into the outward direction away from the corner of the two adjacent corner reflectors 1000 and 1002.

The purpose of the corner reflector is to collimate the RF energy from the antenna in the forward direction. Note that while a plane reflector can be used to direct the RF energy, the geometrical shape of the plane reflector must be changed so as to prohibit radiation in the back and sides. FIG. 1 shows a comparison of different reflection configurations. For simplicity of design and ease of manufacturing, a 90° corner reflector was used. Other angle corner reflector and possibly other shapes (parabolic for example) can be used to shape and direct the beam as long as it is an open structure and not an enclosed waveguide cavity as mentioned above. Typically corner reflectors have been used in passive targets for radar and communication applications. Corner reflector backed antennas (dipole fed) have also been used for home televisions for receive only. All these application are for passive single corner reflector antennas. Using a corner reflector backed antenna in an array with active electronics for transmit and receive is an advancement to the prior art.

The corner reflector backed wideband monopole radiating element with cylindrical probe has been modeled and analyzed using Ansoft's HESS as illustrated in FIG. 11. The analysis results plotted in FIGS. 11 show the predicted performance across the full frequency band with room for improvements in match (with and without tuning with a matching circuit) and beam width by adjusting the dimensions of the matching circuit, probe and corner reflector and angle of the reflector where a coaxial feed is used.

FIG. 12 is a graph illustrating a microstrip matching circuit has been designed to improve the match across the 800 MHz, to 2.8 GHz frequency band. In FIG. 12, a single element with a microstrip feed without matching and circuit simulation with a matching circuit is illustrated. The HFSS simulation 1200 shows a single element as well as the matching circuit in the simulation including the scattering parameters that that includes the radiating element. The matching circuit simulation 1202 does not include the single element. Thus, the matching circuit simulation 1202 includes the matching circuit, but excludes the load.

FIG. 13 is a graph illustrating a comparison of predicted performances shows the correlation between ANSOFT FIBS 3D EM modeling tool and Agilent Advanced Design System (ADS) Circuit Simulator Tool. The plot of FIG. 13 shows the circuit simulation of the matching circuit effect (solid line) 1300 and the HFSS simulations with the matching circuit (dotted line) 1302.

FIG. 14 is a graph illustrating 3D plots of the antenna radiation pattern predicted for the corner reflector backed monopole showing the wide band performance at three different frequencies.

FIG. 15 is a graph illustrating 3D plots of the antenna radiation pattern predicted for the corner reflector backed monopole showing the wide band performance at three different frequencies.

FIG. 16 is a graph illustrating 3D plots of the antenna radiation pattern predicted for the corner reflector backed monopole showing the wide band performance at three different frequencies.

FIGS. 17-19 are graphs illustrating 2D cuts of the antenna radiating pattern predicted for the corner reflector backed monopole showing the wide band performances.

In summary, the single element with matching has sufficient performance for the following bands:

Bands Covered:

| | |
|---|---|
| 880 MHz | PCS |
| 1900 MHz | PCS, LTE |
| 2300 MHz | LTE |
| 2400 MHz | Wi-Fi |
| 2500 MHz | LTE |

Further development may include the additional LTE hands. The monopole probe can be excited to radiate RF energy by using a coax connector whose center pin is inserted through an opening in the ground plane connect the cylindrical monopole probe. The outer conductor of the connector shell would be connected to the ground plane.

Another approach is shown in FIGS. 20 and 21. The ground plane 2000 is part of a printed circuit board 2002 with a channelized microstrip transmission line 2004 running on the opposite side of the circuit board. A pin 2006 inserted through the board opening and soldered to the end of the microstrip line at one end is connect to the mono the cylindrical monopole probe 2008 at the other end of the pin 2006. The advantage of using the microstrip line/pin combination to excite the cylindrical monopole probe 2008 is the ease of assembly to integrate additional matching and filter circuitry onto the printed microstrip line. The channelized microstrip 2004 is used to isolate and minimize cross talk between adjacent RF, control and DC power line located on the same circuit board. Corner reflectors 2010 comprising a metalized structure are positioned orthogonal to the ground plane 2000. Channelization the microstrip 2004 is achieved by including a ground plane 2000 on the same plane as the microstrip line 2004 and connecting the top and bottom ground planes with plated through holes.

In FIG. 21, the excitation of the monopole probe (not shown) is accomplished by sending the RF signal from a channelized microstrip line 2100 to a coaxial pin 2102 running through the circuit board to the probe the circuit board containing the channelized microstrip line 2102 and may comprise a single layer board with copper or metal circuitry printed on both sides 2104. It is also conceivable that the channelized microstrip 2102 may include multiple layers as part of a laminated multi-layer mixed signal circuit board containing not RF signal lines but also power, digital control and integrated fiber optical lines.

The cylindrical monopole probe can be replaced with a printed patch 2200 that also function as a microstrip probe as illustrated in FIG. 22. Such a printed probe can be modeled on HFSS and the results indicate predicted performance comparable to the cylindrical probe. A prototype corner reflector 2202 back printed monopole radiator 2200 with printed probe can be constructed and positioned relative to the corner reflectors 2202. The measured return loss of the prototype tracked the predicted return loss of the HFSS model as show in FIG. 23. Note, a printed circuit board 2204 is not necessarily needed for the printed probe 2200 for structural support. Instead, the thin metal probe 2200 may be constructed with enough structural rigidity to support itself.

FIG. 23 is a graph illustrating a comparison of predicted and measured performances and the respective correlation between the HFSS model and the prototype corner reflector backed monopole antenna element. The measured data is shown 2400 and the HESS simulation data is shown as 2402.

FIG. 24 is an exploded view of the star array small electronic assembly structure. Please note, other electronics configurations can be used depending on component cost and availability. The radiators 2400 may be arranged in a polygonal/circular pattern. As seen in FIG. 25, the edges of the each corner reflector 2400 have been designed to connect to the adjacent ones to form a continuous conducting “star array” shape reflector ring structure 2400 to package and shield the electronics housed inside. This star reflector ring 2400 may be mounted onto the printed circuit mother board containing the microstrip lines and supporting the monopole probes. A power module 2402 can be electronically coupled to the processing module 2404 and shielded by the RF shield 2406. A cover/radome 2408 and bottom base 2410 can encompass the components and modules to protect the antenna array from environmental effects.

The printed circuit mother board may also be designed to route RF, DC power and digital control signals. Thus, the RF, control, and power electronic components can be surface mounted onto the mother board or stacked daughter card assemblies (see FIG. 25) can be connector attached, containing the functions described into block diagram in FIGS. 5, 6 and 7 onto the mother board.

FIG. 25 is a perspective view of a star array antenna mother board sub-assembly structure. The monopole antennas 2500 are positioned between the reflective corners 2502. The reflective corners 2502 may be positioned on top of an RF and mixed signal printed circuit board 2504.

A switchable and reconfigurable polygonal antenna star array of corner reflector backed wideband monopole radiating elements can be configured with switching capabilities. Switching can be performed in RF by the TR modules or digitally with the FPGA of the SDR. Being a switchable and reconfigurable polygonal antenna array, 360 degree coverage beam steering is achieved by turning on and off elements. Beam forming/steering can be performed when the elements within the star array are combined and each element are adjusted for amplitude, time-delay or phase shift depending of the available processing electronic and memory. This is doable because the corner reflector backed wideband monopole radiating elements are smaller than conventional wideband elements with comparable wide bandwidth capability with better isolation between elements and front to back ratio in its radiation pattern. Again depending with the available processing electronics, memory and software algorithms, adaptive array signal processing, select blanking, frequency hopping/channel control, fractional frequency reuse and MIMO can be used to further shape and steering the beam(s) for greater flexibility in coverage and inter-cell interference management. FIGS. 26 through 30 illustrate the various beam configurations the star array antenna is capable of generating by using the electronic functions of the TR module as described in FIGS. 5, 6 and 7.

FIG. 26 is a top view of a system capable of switching on and off single beams enables the Star Array Antenna to cover 360°.

FIG. 27 is a top view of a system with two (2) adjacent element turned enable the star array antenna to perform discriminative coverage and evaluation.

FIG. 28 is a top view of a system with three (3) adjacent element turned enable the star array antenna to perform discriminative coverage and evaluation.

FIG. 29 is a top view of a system with four (4) independent elements turned on allowing simultaneous 360° coverage of multiple user/devices.

FIG. 30 is a top view of a system with sixteen (16) independent elements turned on allowing simultaneous 360° coverage of multiple user/devices.

While the illustrations of FIGS. 26 through 30 shows up to a sixteen (16) element star array, smaller array sizes may be achievable for both cost and size reduction. Likewise, larger arrays can also be constructed.

FIG. 31 is a top view of a system CAD model of an eight (8) element star array. The CAD model illustration shown in FIG. 32 shows an eight (8) element star array that was modeled on HFSS.

FIG. 32 is a top view of a system with three (3) adjacent elements with the eight (8) element the Star Array Antenna have better than 20 dB isolation across the full frequency band. The predicted performance resulting from the HFSS analysis show repeatable match for the adjacent elements with isolated adjacent elements indicating that the corner reflector backed monopoles can be used an array elements or as separate independent elements.

FIG. 33 is a chart of the input return loss into each element showing that it is about the same for the three adjacent elements within the eight (8) element star array antenna across the full frequency band.

FIG. 34 is a graph of adjacent elements with the eight (8) element star array antenna having better than twenty (20) dB isolation across the full frequency band. The adjacent elements are shown 3400 and the two (2) element away plot shown at 3402.

While various embodiments of the invention have been described, it will be apparent to those of ordinary skill in the art that many more embodiments and implementations are possible that are within the scope of this invention.

What is claimed is:

1. An antenna array, comprising:
a plurality of antenna elements having a corner reflector positioned so that the plurality antenna elements are shielded from each other;
a power module electronically coupled to the plurality of antenna elements; and
a processing module electronically coupled to the power module.
